(19) United States
(12) Patent Application Publication
(10) Pub. No.: US 2008/0181270 A1
(43) Pub. Date: Jul. 31, 2008

(54) PACKAGING STRUCTURE FOR THE HORIZONTAL CAVITY SURFACE EMITTING LASER DIODE WITH MONITOR PHOTODIODE

(76) Inventors: Ta-Tsung LIN, Hsin-chu (TW); Steve Meng-Yuan Hong, Hsin-chu (TW)

Correspondence Address: HDSL, 4331 STEVENS BATTLE LANE, FAIRFAX, VA, 22033, US

(21) Appl. No.: 11/767,949

(22) Filed: Jun. 25, 2007

(30) Foreign Application Priority Data
Jan. 29, 2007 (TW) 096103164

(51) Int. Cl. H01S 3/13

(52) U.S. Cl. 372/32

(57) ABSTRACT

A package structure for horizontal cavity surface emitting laser diode with monitor photodiode chip includes a header with a plurality of conductive pins, where three conductive pins extend onto the surface of the header. One of the conductive pins is attached to a stage with a slope and a monitor photodiode chip is placed on the top of the stage. A submount is placed among the three conductive pins and is attached to a laser diode chip. The back facet of the laser diode chip is facing the stage. The upward surface emission light of the laser diode chip is focused outside the transparent window by the lens on the transparent window and the horizontal emission light of the laser diode chip is incident on the monitor photodiode chip, whereby the power of the light can be detected.

### BACKGROUND OF THE INVENTION

1. Field of the Invention

The present invention relates to a laser diode, especially to a horizontal cavity surface emitting laser diode.

2. Description of Prior Art

Laser diodes, also frequently referred to as semiconductor lasers, have the advantages of compact size, low power consumption, fast response, shock-proof property, long lifetime, high efficiency and low cost. Therefore, laser diodes gradually gain wide application. On the other hand, the laser diode needs expensive manufacture equipment for precise and high-tech processes.

The laser diode can be classified into short-wavelength and long-wavelength based on the wavelength ranges and applications thereof. The short-wavelength laser has the wavelength range of 390 nm to 950 nm and is applied to the information and display applications such as optical disk drive, laser printer, bar code reader, scanner and pointer. The laser diode with 850 nm wavelength can also be used for optical fiber communication in the data storage market. The long-wavelength laser diodes are the laser diodes with wavelength range from 1310 nm up to few micrometers and are mainly used for optical fiber communication, sensing and spectroscopy.

The conventional surface emitting laser for optical fiber communication, such as stated in the U.S. Pat. No. 6,678,292 B2 with title “TOP CONTACT VCSEL WITH MONITOR” is a vertical cavity surface emitting laser diode. This surface-emission laser diode is combined with a monitor photodiode to detect laser light reflected from a reflective surface of a glass cover, whereby the power of the laser light can be monitored. However, this patent uses monitor chip with large optical reception area. The cost is high for the application in the long wavelength range because the monitor chip with large optical accepting area at 1.3 um or 1.55 um range is expensive.

### SUMMARY OF THE INVENTION

It is an objective of the present invention to provide a package structure for horizontal cavity surface emitting laser diode with monitor photodiode chip having smaller light reception area. One of the pin on the header is used as submount for the the monitor photodiode to simplify package process. It is to be noted that with this design a TO46 header with reduced cost can be used.

Accordingly, the present invention provides a package structure for horizontal cavity surface emitting laser diode with a monitor photodiode chip, including:

a header, which includes two symmetric triangular dents and a rectangular dent;

a pin set, which comprises a plurality of conducive pins arranged on the header, wherein three conductive pins pass the header and extend onto the surface of the header and a flat stage sits on top of one pins thereof;

a submount placed on the surface of the header and between the three pins;

a laser diode chip mounted to the top of the submount and the back facet of the laser diode chip facing the stage; and

a monitor photodiode mounted onto the stage and facing the back facet of the laser diode chip. The monitor photodiode was used to measure the light output from the laser diode back facet.

### BRIEF DESCRIPTION OF DRAWING

The major features of this invention are set forth particularly in the appended claims. The invention itself however may be best understood by referring to the following detailed descriptions of the invention, which describes certain exemplary embodiments of the invention, in conjunction with the following Figures:

FIG. 1 shows the perspective view of the package structure for horizontal cavity surface emitting laser diode with a monitor photodiode chip based on the present invention.

FIG. 2 shows the top view of the package structure for horizontal cavity surface emitting laser diode with a monitor photodiode chip based on the present invention.

FIG. 3 shows the section view of the package structure for horizontal cavity surface emitting laser diode with a monitor photodiode chip based on the present invention.

FIG. 4 shows the top view of the package structure for horizontal cavity surface emitting laser diode with a monitor photodiode chip based on another preferred embodiment of the present invention.

FIG. 5 shows the section view of the package structure for horizontal cavity surface emitting laser diode with a monitor photodiode chip based on another preferred embodiment of the present invention.

FIG. 6 shows the top view of the package structure for horizontal cavity surface emitting laser diode with a monitor photodiode chip based on still another preferred embodiment of the present invention.

FIG. 7 shows the section view of the package structure for horizontal cavity surface emitting laser diode with a monitor photodiode chip based on still another preferred embodiment of the present invention.

### DETAILED DESCRIPTION OF THE INVENTION

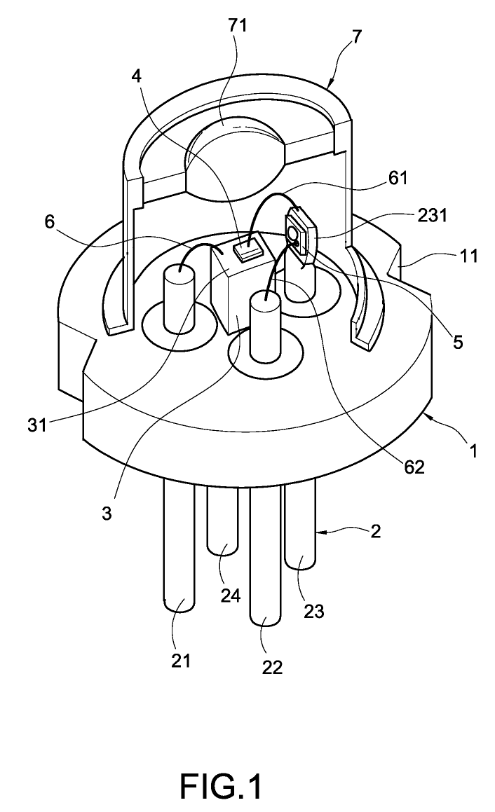

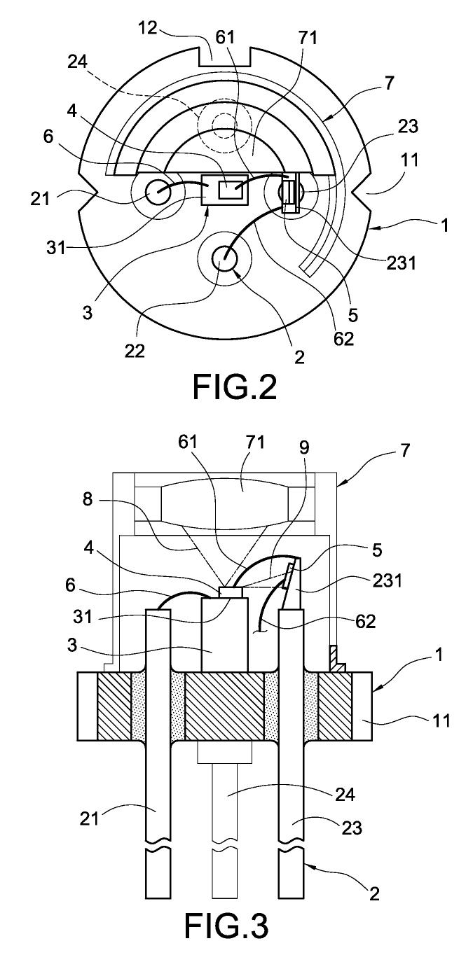

With reference to FIGS. 1 and 2, the horizontal cavity surface emitting laser diode package based on the first preferred embodiment of the present invention includes a header 1, a pin set 2, a submount 3, a laser diode chip 4, a monitor photodiode chip 5 and a cap 7.

The header 1 is a round base for placing chips on the top. The cap xx is used for air-tight sealing the chips and the lens on the top used for focusing the laser light is made with molten glass. The header 1 comprises two symmetric triangular dents 11 and a rectangular dent 12 on perimeter thereof. The dents 11 and 12 are used for positioning in the diebond and wire bond process.

The pin set 2 comprises a plurality of conductive pins 21, 22, 23, and 24, wherein three conductive pins 21, 22 and 23 pass the header 1 and extend to surface of the header 1. The conductive pin 23 comprises a stage 231 having a bevel 232 and is used to mount the photo detector 5.

The submount 3 is fixed to the surface of the header 1 and among the three conductive pins 21, 22, 23, and 24. The submount 3 is made of, but not limited to, AlN or SiC and is of rectangular shape. The height of the submount 3 can be adjusted to modify the focus length. Moreover, one of Ti, Pt and Au metal is coated on surface of the submount 3 and silvery epoxy is pasted to fix the Laser diode 4 to the submount 3.

The laser diode chip 4 is fixed on a top face 31 of the submount 3 and a light emitting spot of the laser diode chip 4 is aligned to the center of the header 1. The back facet (the face that is not used for the emission output of the laser diode) of the laser diode chip 4 is facing the stage 231 of the pin 23. The laser diode chip 4 shown in this figure includes upward surface emission mode (front facet) and horizontal emission mode (back facet).

The monitor photodiode chip 5 is a light detection chip with small light reception area and fixed to the stage 231. The monitor photodiode chip 5 is facing the back facet of the laser diode 4 in order to receive horizontal light from the laser diode chip 4 and detect the power of the emitted horizontal light.

After the above elements are attached, wire bonding is then performed. The conductive wire 6 is soldered to the pin 21 at one end thereof and soldered to the top face 31 at another end thereof. The stage 231 is soldered to a conductive wire 61, where one end of the conductive wire 61 is soldered to the surface of the laser diode chip 4. The pin 22 is soldered to a wire 62, where one end of the conductive wire 62 is soldered to the surface of the monitor photodiode chip 5.

After the conductive wires 6, 61, 62 are soldered, a cap 7 is assembled to the header 1. The cap 7 comprises a transparent window 71 with position corresponding to the light emitting path of the laser diode chip 4. The transparent window 71 shown in this figure is a convex lens.

FIG. 3 shows a section view of a horizontal cavity surface emitting laser diode based on the present invention. When the pins 21, 22 and 23 are connected to electrical power, light 8 is emitted vertical upward from the surface of the laser diode chip 4. The light 8 is focused by the transparent window 71 and focused outside the transparent window 71. Horizontal light 9 is impinged on the monitor photodiode chip 5. The monitor photodiode chip 5 monitors the power of the focused light.

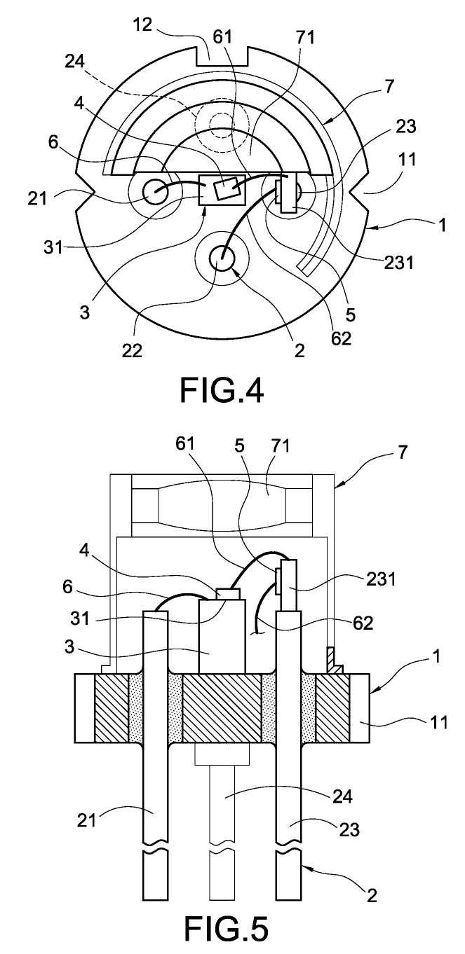

With reference to FIGS. 4 and 5, the horizontal cavity surface emitting laser diode in another preferred embodiment of the present invention is similar to that shown in FIGS. 1 to 3 except that the laser diode chip 4 is rotated an angle (15 degree), while the light emitting spot is attached to the center of the header 1 when the laser diode chip 4 is attached to the header 1. The light is incident onto active reception region of the monitor photodiode chip 5. The rotation angle can prevent the back-scattered laser power from entering into the laser cavity after reflection from the surface of the monitor photodiode chip 5.

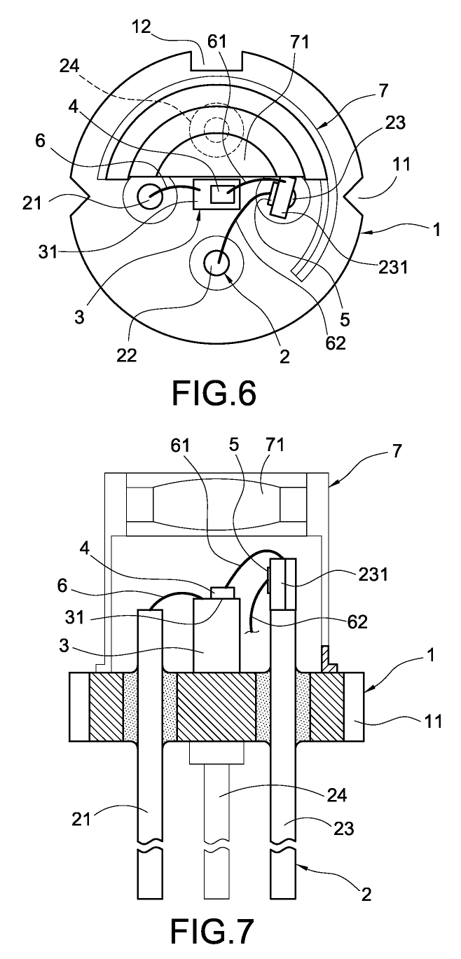

FIGS. 6 and 7 show still another preferred embodiment of the present invention. The horizontal cavity surface emitting laser diode is similar to that shown in FIGS. 1 to 3 except that the light emitting spot is attached to the center of the header 1 and the stage 231 is rotated an angle (15 degree) and the light is incident into active reception region of the monitor photodiode chip 5. The rotation angle can prevent the back-scattered laser power from entering into the laser cavity after reflection from the surface of the monitor photodiode chip 5.

Although the present invention has been described with reference to the preferred embodiment thereof, it will be understood that the invention is not limited to the details thereof Various substitutions and modifications have been suggested in the foregoing descriptions, and others with the ordinary skills in the art although not mentioned shall also be included. Therefore, all such substitutions and modifications are intended to be covered within the scope of the invention as defined in the appended claims.

What is claimed is:

1. A package structure for horizontal cavity surface emitting laser diode, comprising:
a header;
a pin set comprising a plurality of conducive pins arranged on the header, wherein three conductive pins go through the the header and extend to the surface of the header and one of the three pins comprises a stage at topside thereof;
a submount fixed on the surface of the header and among the three pins;
a laser diode chip fixed to a top face of the submount and a back facet of the laser diode chip and facing the stage; and
a monitor photodiode chip fixed to the stage and facing the back facet of the laser diode chip.

2. The package structure for horizontal cavity surface emitting laser diode as in claim 1, wherein the header comprises two symmetric triangular dents and a rectangular dent.

3. The package structure for horizontal cavity surface emitting laser diode as in claim 1, wherein the stage comprises a bevel.

4. The package structure for horizontal cavity surface emitting laser diode as in claim 1, wherein the stage is rotated an angle.

5. The package structure for horizontal cavity surface emitting laser diode as in claim 4, wherein the angle is 15 degree.

6. The package structure for horizontal cavity surface emitting laser diode as in claim 1, wherein the stage is made of one of AlN and SiC.

7. The package structure for horizontal cavity surface emitting laser diode as in claim 1, wherein a focus length is adjusted by a height of the header.

8. The package structure for horizontal cavity surface emitting laser diode as in claim 6, wherein the submount is plated with one of Ti, Pt and Au and then is pasted by silvery epoxy.

9. The package structure for horizontal cavity surface emitting laser diode as in claim 1, wherein the laser diode chip has a surface upward emission mode and an outward horizontal emission mode.

10. The package structure for horizontal cavity surface emitting laser diode as in claim 1, wherein the laser diode chip is fixed to the header and is rotated to an angle such that light emitted from the laser diode back facet is incident onto the light reception region of the monitor photodiode chip.

11. The package structure for horizontal cavity surface emitting laser diode as in claim 1, wherein the rotation angle is 15 degree.

12. The package structure for horizontal cavity surface emitting laser diode as in claim 1, wherein the monitor photodiode chip is a photodiode chip with small light reception area.

13. The package structure for horizontal cavity surface emitting laser diode as in claim 1, wherein the one end of a first conductive wire is soldered to a first pin and another end of the first conductive wire is soldered to a top face of the submount; a second conductive wire is soldered to the stage and one end of the second conductive wire is soldered to surface of the laser diode chip; a third conductive wire is soldered to a second pin and one end of the third conductive wire is soldered to surface of the monitor photodiode chip.

14. The package structure for horizontal cavity surface emitting laser diode as in claim 1, wherein a cap is assembled to the header and the cap comprises a transparent window.

15. The package structure for horizontal cavity surface emitting laser diode as in claim 14, wherein the transparent window has a convex lens.
